(19) United States
(12) Patent Application Publication
(10) Pub. No.: US 2009/0119007 A1
(43) Pub. Date: May 7, 2009

(54) Navigation System

(75) Inventors: Toru MURAYAMA, Utsunomiya-shi (JP); Hirofumi Kinoshita, Utsunomiya-shi (JP); Keisuke Kondo, Utsunomiya-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD, Tokyo (JP)

(21) Appl. No.: 12/265,374

(22) Filed: Nov. 5, 2008

(30) Foreign Application Priority Data
Nov. 6, 2007 (JP) 2007-288313

(51) Int. Cl. G01C 21/26

(52) U.S. Cl. 701/208

(57) ABSTRACT

A navigation system including: a map image storage device which stores a map image having a polygon image being correlated to a facility name; a facility information storage device which stores the facility name and a facility location and also correlates the facility name to the facility location; a display device which displays the map image and a pointing image which is movable; a positioning device which specifies a position on the map image with the pointing image; and a destination setting device which sets a destination based on the position specified by the positioning device, wherein in a case where an arbitrary position on the polygon image is specified by the positioning device, the destination setting device retrieves the facility name correlated to the polygon image, retrieves the facility location correlated to the retrieved facility name, and sets the destination to the retrieved facility location.

### BACKGROUND OF THE INVENTION

Priority is claimed on Japanese Patent Application No. 2007-288313, filed Nov. 6, 2007, the contents of which are incorporated herein by reference.

1. Field of the Invention

The present invention relates to a navigation system.

2. Description of the Related Art

Conventionally, a navigation system in which a destination is set with a cursor movable on a map image which is displayed on a display is known (see, for example, Japanese Unexamined Patent Application, First Publication No. H11-316131, and Japanese Unexamined Patent Application, First Publication No. 2004-53304).

In the above-described navigation system according to the related art, when a destination is set in accordance with a position of a cursor on a map image, a position closest to the position of the cursor is selected from multiple positions on the map image. The positions each include positional information such as address (i.e., selectable positions which can be selected with the cursor). As a result, the destination set based on the positional information corresponding to the closest position may not be a desired destination.

For example, when an operator specifies a proper facility for setting a destination thereto on a map image by placing the cursor in a polygon image corresponding to the facility, a selectable position closest to the cursor is selected. However, if the selected position is away from a predetermined point which is relatively important such as an entrance of the facility, a problem occurs in that appropriate route guidance cannot be performed.

In view of the above described circumstances, the present invention has an object to provide a navigation system in which a destination can appropriately be set.

### SUMMARY OF THE INVENTION

In order to solve the above-described problem, the present invention employs the following. Namely, the present invention employs a navigation system including: a map image storage device which stores a map image having a polygon image being correlated to a facility name; a facility information storage device which stores the facility name and a facility location and also correlates the facility name to the facility location; a display device which displays the map image and a pointing image which is movable on the map image; a positioning device which specifies a position on the map image with the pointing image; and a destination setting device which sets a destination based on the position on the map image specified by the positioning device, wherein in a case where an arbitrary position on the polygon image in the map image is specified by the positioning device, the destination setting device retrieves the facility name correlated to the polygon image stored in the map image storage device, retrieves the facility location correlated to the retrieved facility name stored in the facility information storage device, and sets the destination to the retrieved facility location.

According to the above-described navigation system, when an arbitrary point on a polygon image in a map image is specified, the location of the facility stored in the facility information storage device is first retrieved using the facility name corresponding to the polygon image, and then the destination is set to the location of the facility. Therefore, by setting in advance the location of the facility to an entrance of the facility or the like, a destination can appropriately be selected in response to an input operation by an operator.

It may be arranged such that the facility information storage device stores a location of a parking lot provided at the facility as the facility location.

In this case, by setting in advance the location of the facility to a location of a parking lot thereof, the vehicle can appropriately be guided to the destination.

It may be arranged such that the facility information storage device stores a location of an entrance of the facility as the facility location.

In this case, by setting in advance the location of the facility to a location of an entrance thereof, the vehicle can appropriately be guided to the destination.

### BRIEF DESCRIPTION OF THE DRAWINGS

FIG. 1 is a block diagram showing a navigation system according to an embodiment of the present invention.

FIG. 2 is a view showing an arrangement of an input operation section of the navigation system according to the embodiment.

FIG. 3 is a perspective view showing the input operation section of the navigation system according to the embodiment.

FIG. 4 is a cross-sectional view showing the input operation section of the navigation system according to the embodiment.

FIG. 5A and 5B are displayed images of a display device of the navigation system according to the embodiment.

FIG. 6 is a flow chart showing an procedure for setting a destination in the navigation system according to the embodiment.

### DETAILED DESCRIPTION OF THE INVENTION

A navigation system according to an embodiment of the present invention will be explained with reference to the drawings.

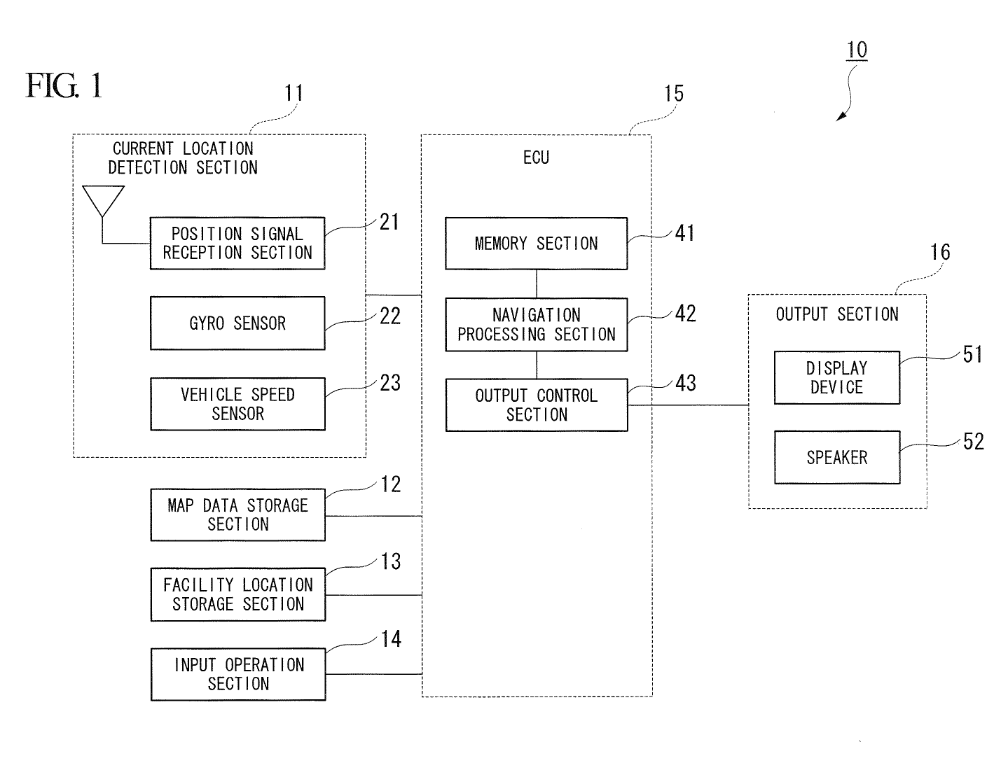

A navigation system 10 according to the present embodiment includes, as shown in FIG. 1, a current location detection section 11, a map data storage section 12 (map image storage device), a facility location storage section 13 (facility information storage), an input operation section 14 (positioning and destination setting device), an ECU 15 (positioning and destination setting device), and an output section 16.

The current location detection section 11 has a position signal reception section 21, a gyro sensor 22, and a vehicle speed sensor 23 which measures the speed of a vehicle. The position signal reception section 21 receives a GPS (Global Positioning System) signal for measuring the position of a vehicle using artificial satellites or the like, or a signal such as D (Differential) GPS signal which improves an accuracy of positioning by compensating errors in a GPS signal using a base station. The gyro sensor 22 detects where the present vehicle directs in the horizontal plane, an inclination angle thereof (e.g., an inclination angle of the longitudinal axis of the vehicle around a vertical axis, or a yaw angle which is the turning angle around a vertical axis at the vehicle center of gravity), and variations of the inclination angle (e.g., yaw rate). The current location of the vehicle is calculated based on measured results of positioning signals received by the position signal reception section 21 or by way of calculation processing for autonomous navigation based on detected signals such as vehicle speeds measured by the vehicle speed sensor 23 and yaw rate detected by the gyro sensor 22.

The map storage section 12 contains, for example, map data which can be displayed on a display screen 51a (display device) of the display device 51 in the output section 16, and road data such as the shape of roads and how roads are connected.

The map data includes: contour map data; polygon data which corresponds to various facilities, city blocks, lakes and the like; character type data such as facility names correlated to respective polygon data and names of places; and various symbol type data.

The road data includes nodes (e.g. points for figuring our the shape of roads), links which are lines connecting respective nodes, distances between the respective nodes, road types, road width, intersection angles of roads, road shapes, and the like.

The facility location storage section 13 contains names of various facilities, facility locations which are each correlated to the facility names (e.g., a coordinate of a parking lot provided at a facility, a coordinate of an entrance of a facility, or the like), telephone numbers which are each correlated to the names of the facilities, and the like as POI (Point Of Interest) data.

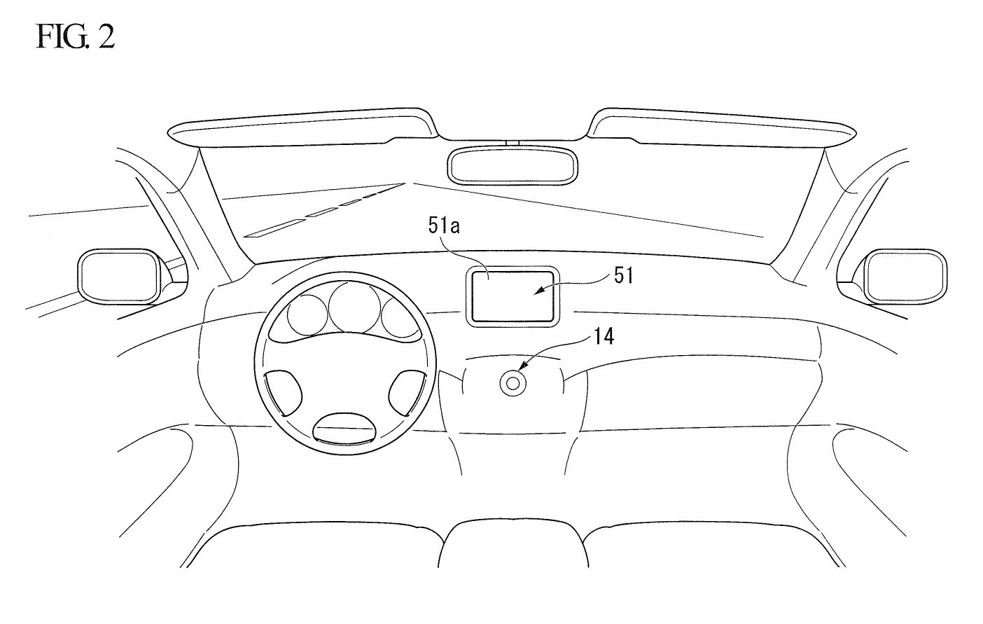

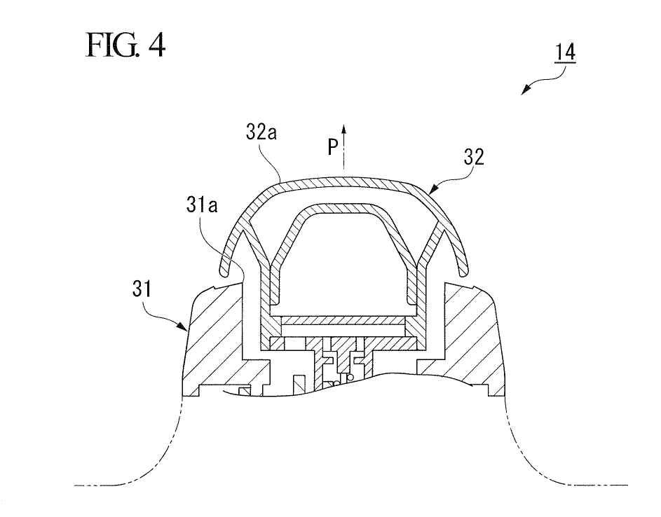

The input operation section 14 is arranged at a position lower than the display device 51 of the output section 16 as shown in FIG. 2 through FIG. 4.

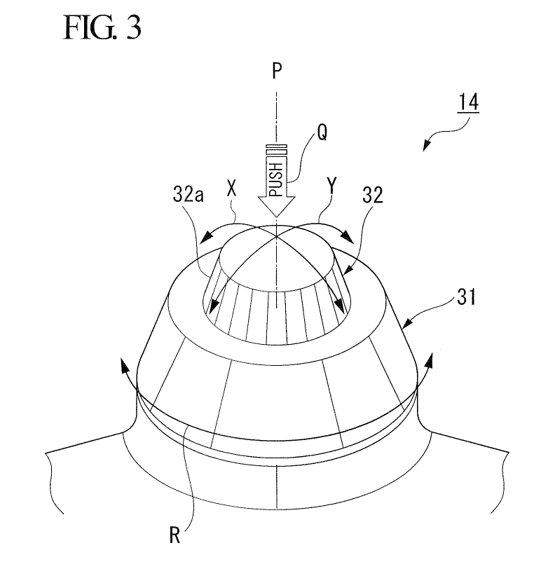

The rotation operation member 31 of substantially a cylindrical shape is capable of being rotated around an P axis (e.g. in a direction shown with an arrow R in FIG. 3).

The slide operation member 32 of substantially a cylindrical shape, the outer diameter of which is smaller than the inner diameter of the rotation operation member 31, is disposed in the inner side of the operation member 31, in which the slide operation member 32 and the rotation operation member 31 are concentrically arranged. The end portion 32a of the slide operation member 32 is arranged so as to protrude from an opening end 31a of the rotation operation member 31. The slide operation member 32 can be displaced in a direction of the P axis and arbitrary directions perpendicular to the P axis (e.g., in directions shown with arrows X and Y in FIG. 3).

Reference positions for the slide operation member 32 are each set in the direction of the P axis and the direction perpendicular to the P axis. If no input operation by an operator (e.g., a press operation in the direction of the P axis, or a slide operation in the directions perpendicular to the P axis) is performed, the slide operation member 32 is automatically back to the reference positions by a suitable restore mechanism (not shown in the drawings).

In addition, the input operation section 14 has a sensor (not shown in the drawings) such as an encoder which detects a rotation angle and a rotation rate of the rotation operation member 31 and a sensor (not shown in the drawings) which detects displacements of the slide operation member 32 in the direction of the P axis and the directions perpendicular to the P axis. Signals of detected values output from these sensors are input to the ECU 15.

The ECU has, for example, a memory section 41, a navigation processing section 42, and output control section 43.

The memory section 41 stores a current location output from the current location detection section 11 and a destination set through an input operation by an operator with the input operation section 14, for example.

In addition, the memory section 41 stores one of a plurality of destinations as a final destination in accordance with an input operation with the input operation section 14 by an operator, while storing the other destinations as route points between the current location and the final destination. Further, the memory section 41 stores the order of all the destinations.

The navigation processing section 42 performs map matching to road data obtained from the map data storage section 12 based on a current location output from the current location detection section 11. In addition, the navigation processing section 42 performs route search, route guidance, or the like, and outputs a control command to the display device 51 and a speaker 52 of the output section 16.

The output control section 43 controls the display device 51 and the speaker 52 of the output section 16 in accordance with control command output from the navigation processing section 42 or an input operation with input operation section 14 by an operator.

An operation of the navigation system according to the present embodiment, especially a procedure for setting a destination will be explained below.

In the navigation processing section 42, when an arbitrary point on a polygon image in a map displayed on the display screen 51a is specified through an input operation with the input operation section 14 by an operator, first a facility name which is prestored and correlated to the polygon image in the map data storage section 12 is retrieved. Then, a facility location prestored and correlated to the facility name in the facility data storage section 13 is retrieved. Thereby, the facility location which is correlated to the facility name correspondent to the polygon image specified by the operator is extracted, and the destination is set to the extracted facility location.

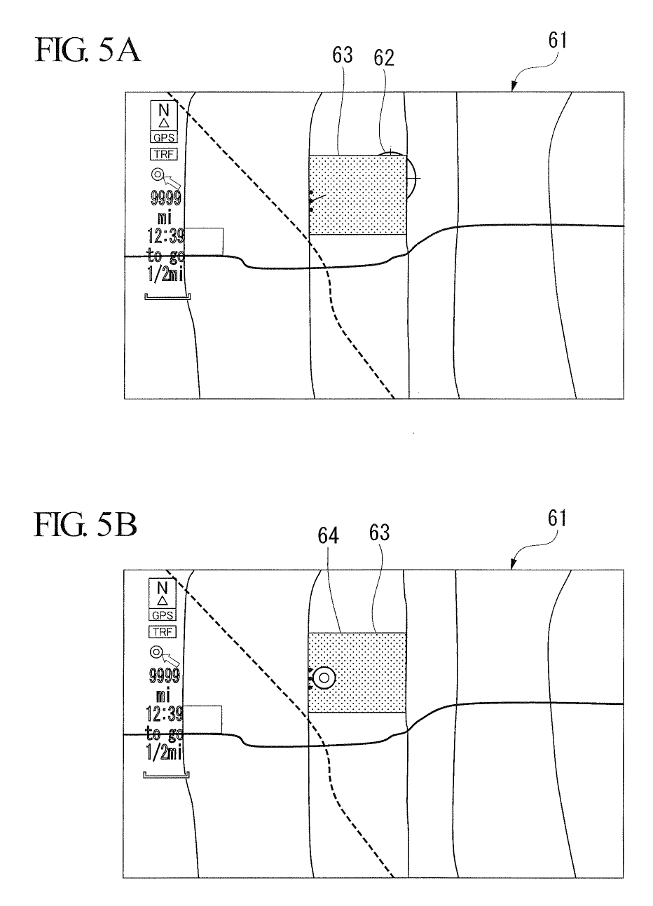

As shown in FIG. 5A, for example, first an image of a map (map image) retrieved from the map data storage section 12 and a pointer image 62 which can be moved on the map image 61 are displayed on the display screen 51a of the display device 51. Next, an arbitrary position on the polygon image 63 in the map image 61 is specified with the pointer image 62 by an operator to perform a predetermined operation for settlement of a destination (e.g., a press operation of the slide operation member 32 of the input operation section 14 in the direction of the P axis). Then, the navigation processing section 42 retrieves a facility name correlated to the specified polygon image 63 prestored in the map data storage section 12 and retrieves a facility location correlated to the retrieved facility name prestored in the facility data storage section 13 (e.g., a coordinate of a parking lot provided at the facility, a coordinate of an entrance of the facility, or the like). Finally, the destination is set to the retrieved facility location. As shown in FIG. 5B, for example, an image 64 showing the destination is then displayed on the map image 61 of the display screen 51a.

A sequence of processing for setting a destination will be explained below.

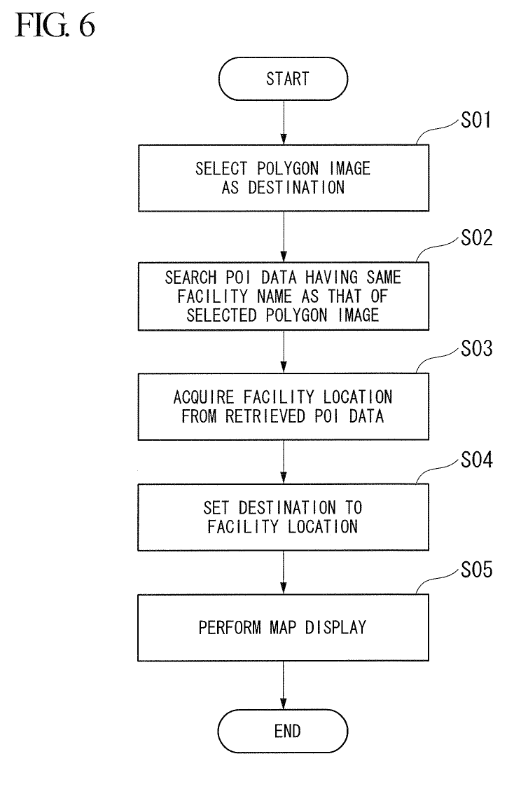

First, as shown in FIG. 6, for example, the polygon image 63 is specified with the pointing image 62 which is movable on the map image 61 displayed on the display screen 51a of the display device 51 to perform a predetermined operation for settlement of a destination (e.g., a press operation of the slide operation member 32 of the input operation section 14 in the direction of the P axis), and thereby the polygon image 63 selected by an operator is acquired in step S01.

In step S02, a facility name correlated to the polygon image 63 selected by the operator is acquired from the map data storage section 12, and POI data having the same facility name as the acquired facility name is searched.

In step S03, a facility location is acquired from the POI data obtained from the facility data storage section 13 (e.g., a coordinate of a parking lot provided at the facility, a coordinate of an entrance of the facility, or the like).

In step S04, the destination is set to the acquired facility location.

In step S05, the destination is displayed on the map image 61 displayed on the display screen 51a, and the sequence of the processing is terminated.

As described above, with the navigation system 10 according to the present embodiment, when an arbitrary position on the polygon image 63 in the map image 61 displayed on the display screen 51a of the display device 51 is specified by an operator, the facility location stored in the facility data storage section 13 is extracted using the facility name correlated to the polygon image 63, and thereby a destination can be set to the facility location. Accordingly, by setting a facility location in advance to coordinates of a parking lot provided at the facility, coordinates of an entrance of the facility, or the like, a destination can appropriately be set in response to an input operation by an operator.

Further, if a facility location correlated with a facility name stored in the facility data storage section 13 is set to a location of a parking lot provided to the facility, the present vehicle can appropriately be guided to the destination.

While preferred an embodiment of the invention has been described and illustrated above, it should be understood that this is exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A navigation system comprising:
a map image storage device which stores a map image having a polygon image being correlated to a facility name;
a facility information storage device which stores the facility name and a facility location and also correlates the facility name to the facility location;
a display device which displays the map image and a pointing image which is movable on the map image;
a positioning device which specifies a position on the map image with the pointing image; and
a destination setting device which sets a destination based on the position on the map image specified by the positioning device, wherein
in a case where an arbitrary position on the polygon image in the map image is specified by the positioning device, the destination setting device retrieves the facility name correlated to the polygon image stored in the map image storage device, retrieves the facility location correlated to the retrieved facility name stored in the facility information storage device, and sets the destination to the retrieved facility location.

2. The navigation system according to claim 1, wherein the facility information storage device stores a location of a parking lot provided at the facility as the facility location.

3. The navigation system according to claim 1, wherein the facility information storage device stores a location of an entrance of the facility as the facility location.
